(19) United States
(12) Patent Application Publication
(10) Pub. No.: US 2014/0352122 A1
(43) Pub. Date: Dec. 4, 2014

(54) METHOD FOR MAINTAINING AND/OR REPAIRING THE SPOUT AREA OF A METALLURGICAL VESSEL

(71) Applicant: SMS Siemag AG, Duesseldorf (DE)

(72) Inventors: Mark Moors, Dusseldorf (DE); Jochen Schlüter, Dortmund (DE); Christoph Wissen, Duisburg (DE); Simon Zovkic, Dusseldorf (DE); Jörg Grünewald, Herdecke (DE)

(21) Appl. No.: 14/364,087

(22) PCT Filed: Dec. 7, 2012
(86) PCT No.: PCT/EP2012/074841

§ 371 Date: Jul. 17, 2014

(30) Foreign Application Priority Data
Dec. 14, 2011 (DE) 10 2011 088 619.2

(51) Int. Cl. C21C 5/44; B22D 45/00; F27D 1/16; B22D 41/00

(52) U.S. Cl. CPC C21C 5/445; B22D 41/001; B22D 45/00; F27D 1/1694
USPC 29/402.08

(57) ABSTRACT

The invention relates to a method for maintaining and/or repairing the spout area (1) of a metallurgical vessel, wherein a substantially hollow-cylindrical sleeve (3) in a perforated brick (2) of the metallurgical vessel is removed. In order to allow the sleeve to be replaced quickly and simply in the event of wear, the method according to the invention has the following steps: a) introducing at least one radially extending slit (4) into the sleeve (3), whereby the sleeve (3) is interrupted at at least one circumferential point (5); b) reaching behind the sleeve (3) or segments (3′, 3″) thereof with a pulling tool (6); c) pulling the sleeve (3) or segments (3, 3″) thereof out of the perforated brick (2), and d) inserting a new sleeve (3) or a new brick material into the perforated brick (2).

The invention relates to a method of maintaining and/or repairing the spout region of a metallurgical vessel according to which a substantially hollow-cylindrical sleeve, which is located in a perforated brick (2) of the metallurgical vessel is removed.

The state-of-the art describes different measures for maintaining and repairing a metallurgical vessel. Reference is made to EP 2 056 983 B1, WO 2010/136159 A1, EP 1 623 778 A1, WO 2010/061022 A1, EP 0 109 348 B1, WO 2004/010067 A1, DE 36 22 327 C2, JP 2010/201468 A, JP 92-73872 A, JP 70-60434 A, and JP 80-19853 A.

Metallurgical vessels are used in iron and steel industry and have outlet openings for molten material. The outlets of such metallurgical vessel, in particular, the outlets of ladle are lined with a brick material (i.e., with a refractory material). In case of ladles, this is effected by introduction of a separate casting sleeve or a combination of several sleeves in a perforated brick located in the ladle. The sleeve or the combination of the sleeves is walled in the perforated brick with mortar.

Because the material wears off and the sleeve, as a rule, wears more rapidly than the refractory lining of the ladle, there is a need in replacing such a sleeve or the combination of sleeves, without the necessity to replace the ladle. To this end, the old used sleeve is knocked out of the perforated brick and is removed, and is finally replaced by a new sleeve that is correspondingly walled in.

The knocking-out of the sleeve or the combination of sleeve is carried out, as a rule, by destroying the refractory brick, primarily by using a jackhammer. The process of removing the broken sleeve is relatively time-consuming and, therefore, expensive. Besides, the impacts which are applied to a metallurgical vessel by the jackhammer are very detrimental.

Accordingly, the object of the invention is to so modify the method of the above-mentioned prior art that it would be possible to carry-out maintenance and/or repair of the spout area of a metallurgical vessel in a shorter time and, thus, economically, and to replace the above-described sleeve or the combination of sleeves. Further, the process should be carried out with a smaller load on metallurgical vessel.

This object is achieved by the invention and is characterized in that the method comprises the steps of:
a) forming at least one radially extending slit in the sleeve whereby the sleeve is interrupted at at least one circumferential location;
b) Gripping from behind the sleeve or its segments with a pulling tool;
c) Pulling the sleeve or its segments from the perforated brick;
d) Inserting a new sleeve or a new stone material in the perforated brick.

The substantially cylindrically formed sleeve consists of, preferably, brick material.

During carrying out the step a), advantageously, at least two radially extending slits are formed in the sleeve, whereby the sleeve is interrupted at at least two circumferential locations and is divided in at least two sleeve segments which then are pulled out of the perforated brick during carrying out the step c).

Advantageously, a number of sleeve segments is produced by forming radially extending slits in the sleeve which extend, respectively, about a same circumferential angle.

The formation of the radially extending slits in the sleeve can be carried out by a milling process. Alternatively, therefor, a sawing process is used. In the last-named case, advantageously, for forming the radially extending slits, a chain saw is used.

The formation of the radially extending slits in the sleeve can be carried out by a tool, wherein the tool is cooled during separation of the sleeve or the brick material.

The tool for forming the radially extending slits in the sleeve can, according to further modification of the method, be driven by an automat.

The carrying out of the above-mentioned step c) can be effected using a hook-shaped pulling tool. This hook-shaped pulling tool can be introduced in an interior of the smelting metallurgical vessel with a hook-shaped gripping section through the at least one slit in the sleeve through the spout area, and is so displaced behind the slit in the interior of the smelting metallurgical vessel, in particular, rotated that the sleeve or its segments are gripped from behind and can be pulled out.

Thus, the invention proposes a method for a metallurgical operation which makes possible removal a refractory material or a brick material out of the gate system of a metallurgical vessel, in particular, removal of a broken casting sleeve out of a ladle.

The invention can be particularly favorably used with metallurgical vessels in form of ladles, basic oxygen converters, AOD—converters, and electrical arc furnaces.

The proposed method serves advantageously for acceleration and improvement of removal processes for an inserted sleeve or brick material.

According to the described preferred embodiment of the method, a brick chain saw is introduced in the pouring channel and saws, with the cutter (chain), one or more slits in the sleeve. The slit extends up to the perforated brick so that the sleeve brick at the saw location is completely broken, and the previously located in the brick tension is released, due to thermal expansion of the sleeve, and is removed. When the sleeve, because of one or more slits, does not have any tension, it can be pulled out of the perforated brick relatively easy with a tool.

In order to increase the durability of the tool, the tool can be cooled advantageously with water that either remains inside the tool or runs in the channel of the metallurgical vessel over the cutting elements. Also, the channel of the vessel can be cooled with water or another cooling medium before insertion of the tool.

The pulling-out of the slitted sleeve or its segments can, e.g., be carried out with a hook-formed tool in which a metal piece is mounted on a metal bar or pipe, and which is introduced in the opening of the vessel, and by rotation of the pulling tool, the pullable brick can be pulled-out. Advantageously here, or the slit or slits formed in the brick can be used for introducing the pulling tool or provide place for a wider hook.

An embodiment of the invention is shown in the drawings. The drawings show:

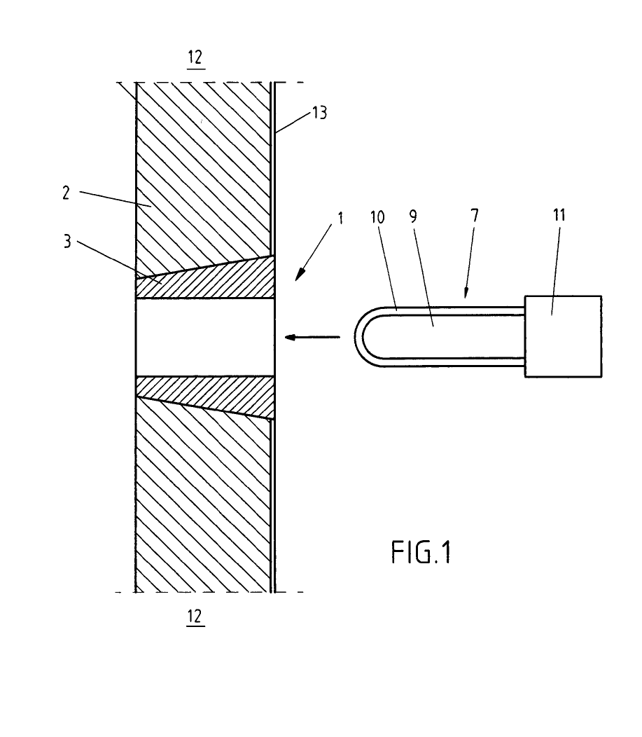

FIG. 1 a schematic cross-sectional side view of a portion of a wall of a ladle with a perforated brick and a worn-out sleeve and with a tool in a not yet operating position;

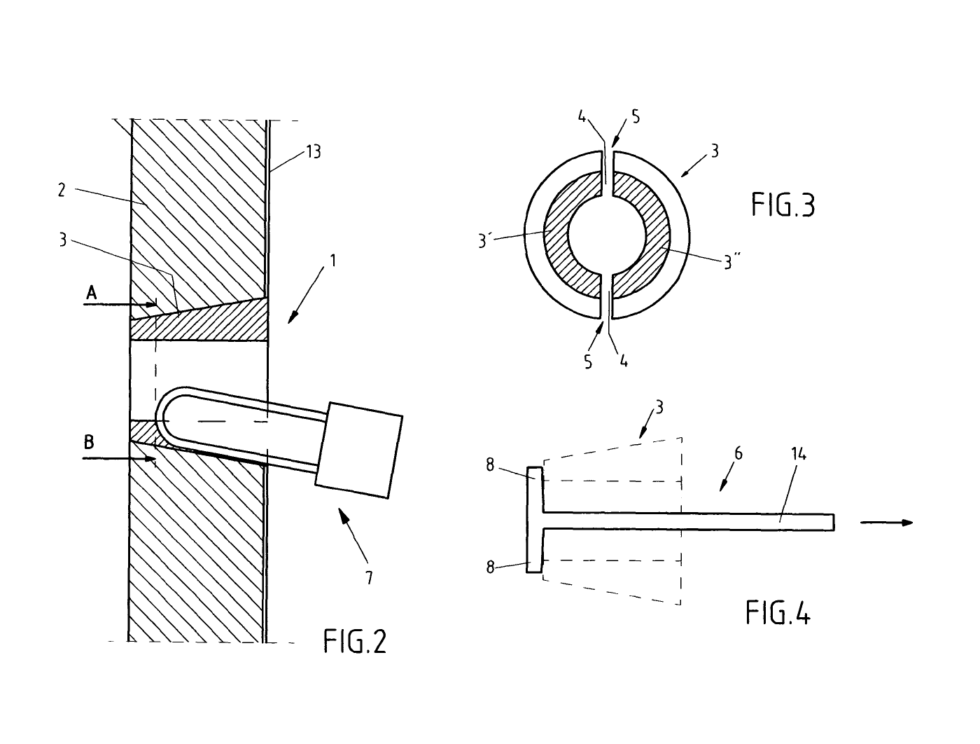

FIG. 2 shows a view similar to that of FIG. 1 but with the tool in an operating position;

FIG. 3 a cross-sectional view along line A-A in FIG. 2 showing the worn-out sleeve of the ladle after treatment with the tool; and

FIG. 4 a side view of a pulling tool, with the pullable sleeve shown with dash lines.

FIG. 1 shows a cut-out of a ladle. The ladle wall is designated with a numeral 13, and behind it, a refractory lining 12 that includes a perforated brick 2, is located. A sleeve 3 is walled in the perforated brick 2 in the spout area 1. The sleeve 3 which consists of a brick material; is already worn out and must be replaced.

For removing the sleeve 3 from the perforated brick 2 the following steps are taken:

A tool 7 in form of a chain saw is provided in the region of the sleeve 3, it can be replaced by a handling tool (robot), not shown. The chain saw has a guide bar 9 over which a chain 10 runs. The chain is driven by a motor located in the housing 11.

As shown in FIG. 2, the chain saw 7 forms a slit in the sleeve 3. This takes place at two circumferential locations.

The treated sleeve 3 is seen in FIG. 3 which is a cross-section A-A according to FIG. 2. As can be seen, a slit 4 is formed in respective circumferential locations 5, so that the sleeve 3 is divided in two sleeve segments 3′ and 3″.

Thereafter, the two available, generally even more than two, sleeve segments 3′ and 3″ can be pulled out from the perforated brick 2 with a pulling tool 6 having gripping sections 8. The pulling tool 6 is shown in FIG. 4. Here, it can be seen that the two gripping sections 8, which are arranged on the bar 14, grip the sleeve segments from behind, so that they can be pulled out. The pulling tool can be introduced into the perforated brick or into the sleeve manually or by the handling tool (robot).

During this, the sawed slit 4 can be used for introducing the gripping section 8 into the interior of the metallurgical vessel. If this takes place, the bar 14 can be pivoted by 90° so that the hook-shaped gripping sections 8 are located behind the sleeve segments to that the same can be pulled out (bayonet principle).

After complete removal of the sleeve 3 or its segments 3′, 3″, a new sleeve 3 can be inserted and fixedly walled in after, if necessary, treatment of the surface of the perforated brick 2.

Generally, the described procedure permits to remove sleeves or worn-out brick material from a metallurgical vessel, wherein the method can be used for a number of such vessels.

The tool 7 can be actively cooled during its use. Before or during the formation of the slit or the slits 4, the sleeve region or the region of the removable brick material can be cooled.

### LIST OF REFERENCE NUMERALS

1 Spout area
2 Perforated brick
3 Sleeve
3′ Sleeve segment
3″ Sleeve segment
4 Slit
5 Circumferential location
6 Pulling tool
7 Tool (chain saw)
8 Hook-shaped gripped section
9 Guide bar
10 Chain
11 Housing with motor
12 Refractory lining
13 Ladle wall
14 Bar

1. A method of maintaining and/or repairing a spout area (1) of a metallurgical vessel according to which a substantially hollow-cylindrical sleeve, which is located in a perforated brick (2) of the metallurgical vessel, is removed, characterized in that
the method comprises the steps of
a) forming at least one radially extending slit in the sleeve (3), whereby the sleeve (3) is interrupted at least one circumferential location;
b) Gripping from behind the sleeve (3) or segments (3′, 3″) thereof with a pulling tool (6);
c) Pulling the sleeve (3) or the segments (3′ 3″) thereof from the perforated brick (2);
d) Inserting a new sleeve (3) or a new brick material in the perforated brick (2).

2. A method according to claim 1, characterized in that during carrying out the step (a) according to claim 1, at least two radially extending slits (4) are formed in the sleeve (3), whereby the sleeve (3) is interrupted at at least two circumferential locations (5) and is divided in at least two sleeve segments (3′, 3″) which then are pulled out of the perforated brick (2) during carrying out the step c) of claim 1.

3. A method according to claim 2, characterized in that a number of sleeve segments (3′, 3″) are produced by forming radially extending slits (4) in the sleeve (3) which extend, respectively, about a same circumferential angle.

4. A method according to claim 2, characterized in that the formation of the radially extending slits (4) in the sleeve (3) is carried out by a milling process.

5. A method according to claim 2, characterized in that the formation of the radially extending slits (4) in the sleeve (3) is carried out by a sawing process.

6. A method according to claim 5, characterized in that for forming of the radially extending slits (4), a chain saw (7) is used.

7. A method according to claim 2, characterized in that the formation of the radially extending slits (4) in the sleeve (3) is carried out by a tool (7), wherein the tool (7) is cooled during separation of the sleeve (3).

8. A method according to claim 2, characterized in that the tool (7) for forming the radially extending slits (4) in the sleeve (3) is driven by a handling automat.

9. A method according to claim 1, characterized in that the step c) according to claim 1 is carried out using a hook-shaped pulling tool (6).

10. A method according to claim 9, characterized in that the hook-shaped pulling tool (6) is introduced in an interior of the smelting metallurgical vessel with a hook-shaped gripping section (8) through the at least one slit (4) in the sleeve (3) through the spout area, and is so displaced behind the slit (4) in the interior of the smelting metallurgical vessel, in particular, rotated that the sleeve (3) or the segments (3′, 3″) thereof are gripped from behind and can be pulled out.
